(19) United States
(12) Patent Application Publication
(10) Pub. No.: US 2025/0335115 A1
(43) Pub. Date: Oct. 30, 2025

(54) METHOD AND SYSTEM FOR MIGRATING FILE

(71) Applicant: Dell Products L.P., Round Rock, TX (US)

(72) Inventors: Weibing Zhang, Beijing (CN); Yuanyang Wu, Shanghai (CN)

(21) Appl. No.: 18/929,881

(22) Filed: Oct. 29, 2024

(30) Foreign Application Priority Data
Apr. 26, 2024 (CN) 202410516262.7

(51) Int. Cl. G06F 3/06

(52) U.S. Cl. CPC G06F 3/0647; G06F 3/0617; G06F 3/0683

(57) ABSTRACT

Techniques for migrating a file involve determining, at a source storage device, a file to be migrated in response to receiving a request for migrating a file, where multiple disks in the source storage device are divided into first multiple tiers based on types of the disks. Such techniques further involve acquiring data of the file and a first identifier of a first tier for storing the data among the first multiple tiers. Such techniques further involve sending the data and the first identifier to a destination storage device, to store the file in a second tier corresponding to the first tier among second multiple tiers of the destination storage device, where multiple disks in the destination storage device are divided into second multiple tiers based on types of the disks. Such techniques may ensure the service quality for user data and reducing the abrasion of disk devices.

### CROSS-REFERENCE TO RELATED APPLICATION

This application claims priority to Chinese Patent Application No. CN202410516262.7, on file at the China National Intellectual Property Administration (CNIPA), having a filing date of Apr. 26, 2024, and having “METHOD AND SYSTEM FOR MIGRATING FILE” as a title, the contents and teachings of which are herein incorporated by reference in their entirety.

### TECHNICAL FIELD

Embodiments of the present disclosure generally relate to the field of data migration, and in particular, to a method and a system for migrating a file.

### BACKGROUND

As storage products evolve, users usually choose to technologically update by replacing old devices with new ones. Such updating of devices also occurs when a user changes the business scale. When devices are replaced, data migration is essential for ensuring data availability and retaining client base during migration to a new storage platform. Supporting data migration is crucial regardless of whether as part of technological upgrades or operated with existing hardware.

Data migration involves transmitting data and host connections from one storage system to another. Many factors need to be considered when migration is carried out. The user should be allowed to carry out the updating without interrupting client access. The user rolls the new system to transparently move data from the existing system to a new system. To improve the user experience to the greatest extent, it is required to perform transparent migration without affecting data access from the host, thereby minimizing the impact on client services. However, many problems still need to be solved in the process of data migration.

### SUMMARY OF THE INVENTION

Embodiments of the present disclosure provide a method and a system for migrating a file.

According to a first aspect of the present disclosure, a method for migrating a file is provided. The method includes determining, at a source storage device, a file to be migrated in response to receiving a request for migrating a file, where multiple disks in the source storage device are divided into first multiple tiers based on types of the disks. The method further includes acquiring data of the file and a first identifier of a first tier for storing the data among the first multiple tiers. The method further includes sending the data and the first identifier to a destination storage device, to store the file in a second tier corresponding to the first tier among second multiple tiers of the destination storage device, where multiple disks in the destination storage device are divided into second multiple tiers based on types of the disks.

According to a second aspect of the present disclosure, a method for migrating a file is provided. The method includes receiving, at a destination storage device, the data of a file to be migrated from a source storage device and a first identifier of a first tier for storing the data among the first multiple tiers of the source storage device, wherein multiple disks in the source storage device are divided into first multiple tiers based on types of the disks. The method further includes determining a second identifier of a second tier corresponding to the first tier among second multiple tiers of the destination storage device based on the first identifier, wherein multiple disks in the destination storage device are divided into second multiple tiers based on types of the disks. The method further includes storing the data in a destination disk of the second tier based on the second identifier.

According to a third aspect of the present disclosure, a system for migrating a file is provided. The system includes a source storage device; and a destination storage device, wherein the source storage device is configured to: determine a file to be migrated in response to receiving a request for migrating a file, wherein multiple disks in the source storage device are divided into first multiple tiers based on types of the disks; acquire data of the file and a first identifier of a first tier for storing the data among the first multiple tiers, and send the data and the first identifier to the destination storage device; and the destination storage device is configured to: receive the data of the file to be migrated and the first identifier from the source storage device; determine a second identifier of a second tier corresponding to the first tier among second multiple tiers of the destination storage device based on the first identifier, wherein multiple disks in the destination storage device are divided into second multiple tiers based on types of the disks; and store the data in a destination disk of the second tier based on the second identifier.

According to a fourth aspect of the present disclosure, a storage device is provided. The storage device includes at least one processor; and a memory coupled to the at least one processor and having instructions stored thereon, wherein the instructions, when executed by the at least one processor, cause the device to perform actions including: determining a file to be migrated in response to receiving a request for migrating a file, wherein multiple disks in the source storage device are divided into first multiple tiers based on types of the disks; acquiring data of the file and a first identifier of a first tier for storing the data among the first multiple tiers, and sending the data and the first identifier to a destination storage device, to store the file in a second tier corresponding to the first tier among second multiple tiers of the destination storage device, wherein multiple disks in the destination storage device are divided into second multiple tiers based on types of the disks.

According to a fifth aspect of the present disclosure, a storage device is provided. The storage device includes at least one processor; and a memory coupled to the at least one processor and having instructions stored thereon, wherein the instructions, when executed by the at least one processor, cause the device to perform actions including: receiving data of a file to be migrated from a source storage device and a first identifier of a first tier for storing the data among the first multiple tiers of the source storage device, wherein multiple disks in the source storage device are divided into first multiple tiers based on types of the disks; determining a second identifier of a second tier corresponding to the first tier among second multiple tiers of the destination storage device based on the first identifier, wherein multiple disks in the destination storage device are divided into second multiple tiers based on types of the disks; and storing the data in a destination disk of the second tier based on the second identifier.

According to a sixth aspect of the present disclosure, a computer program product is provided, which is tangibly stored on a non-volatile computer-readable medium and includes machine-executable instructions, wherein the machine-executable instructions, when executed, cause a machine to perform the steps of the method in the first or second aspect of the present disclosure.

### BRIEF DESCRIPTION OF THE DRAWINGS

Through more detailed description of example embodiments of the present disclosure with reference to the accompanying drawings, the above and other purposes, features, and advantages of the present disclosure will become more apparent, where identical reference numbers generally represent identical components in the example embodiments of the present disclosure.

FIG. 1 illustrates a schematic diagram of an example environment in which a device and/or a method according to the embodiments of the present disclosure may be implemented;

FIG. 2 illustrates a schematic diagram of an example structure of a system for file migration according to the embodiments of the present disclosure;

FIG. 3 illustrates a schematic diagram of an example structure of a source storage device according to the embodiments of the present disclosure;

FIG. 4 illustrates a schematic diagram of an example structure of a destination storage device according to the embodiments of the present disclosure;

FIG. 5 illustrates a schematic diagram of an example structure of file migration according to the embodiments of the present disclosure;

FIG. 6 illustrates a flow chart of a method for migrating a file according to the embodiments of the present disclosure;

FIG. 7 illustrates a flow chart of another method for migrating a file according to the embodiments of the present disclosure;

FIG. 8 illustrates a schematic diagram of an example of a mapping relationship between layers according to the embodiments of the present disclosure;

FIG. 9 illustrates a schematic diagram of another example of a mapping relationship between layers according to the embodiments of the present disclosure;

FIG. 10 illustrates a schematic diagram of an example of file migration according to the embodiments of the present disclosure;

FIG. 11 illustrates a schematic diagram of an example of remote procedure call according to the embodiments of the present disclosure; and

FIG. 12 illustrates a schematic block diagram of an example device suitable for implementing the embodiments of the present disclosure.

In the accompanying drawings, identical or corresponding numbers represent identical or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for example purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

As mentioned above, many problems still need to be solved in the process of data migration. For example, FAST VP (Fully Automated Storage Tiering for Virtual Pools) monitors the data access mode in a system pool, and dynamically matches the performance requirements of the data with disks offering such performance level. For example, FAST VP divides the disks into three types, called tiers: extreme performance tiers, consisting of flash disks; performance tiers, consisting of SAS (Serial Attached SCSI (Small Computer System Interface)) disks; and capacity tiers, consisting of Near-line SAS (NL-SAS) disks.

FAST-VP calculates temperatures using the configuration information of storage pools and the statistical information of IO (Input/Output), and assigns the temperatures to the storage region (at a slicing granularity of 256 MB) of each pool. The frequently accessed data regions are assigned with a high temperature, while the data regions accessed infrequently are assigned with a low temperature. FAST-VP constructs a priority list of the data regions that should be moved to higher-tier storage (like SSDs (Solid State Drives)) and the data regions that should be moved to lower-tier storage (like NL SAS) according to the configuration information and the temperatures. So, FAST-VP can make an attempt to keep the most frequently accessed data regions in the fastest storage disk to achieve shorter response time.

Data migration helps the user in migration to a new device while maintaining data consistency between the old and new devices, thereby minimizing the impact on the work of the user. However, in the data migration between multi-tier storage systems, the data tier information will be deleted, and all data will observe the FAST-VP policy again at a target station, which breaks the data distribution based on the active temperature of the data, and may impair the IO performance under the same user workload. When the hot data on a fast tier is transmitted to a slow tier at a target end, the IO performance will be affected. After migration, the data will be relocated among tiers, bringing unnecessary IO and worsening the abrasion of SSD disks.

At least to address the above and other potential problems, the embodiments of the present disclosure provide a method for migrating a file. A source storage device may first determine a file to be migrated upon the reception of a request for migrating a file, where multiple disks in the source storage device are divided into first multiple tiers based on types of the disks. Then, the source storage device may acquire the data of the file and a first identifier of a first tier for storing the data among the first multiple tiers. Thus, the source storage device may send the data and the first identifier to a destination storage device, to store the file in a second tier corresponding to the first tier among second multiple tiers of the destination storage device. Likewise, multiple disks in the destination storage device are divided into second multiple tiers based on types of the disks. The method may help retain the active temperature information of the data during data migration, such that the same input and output performance can still be obtained after the data migration, thereby ensuring the service quality for user data and reducing the abrasion of disk devices.

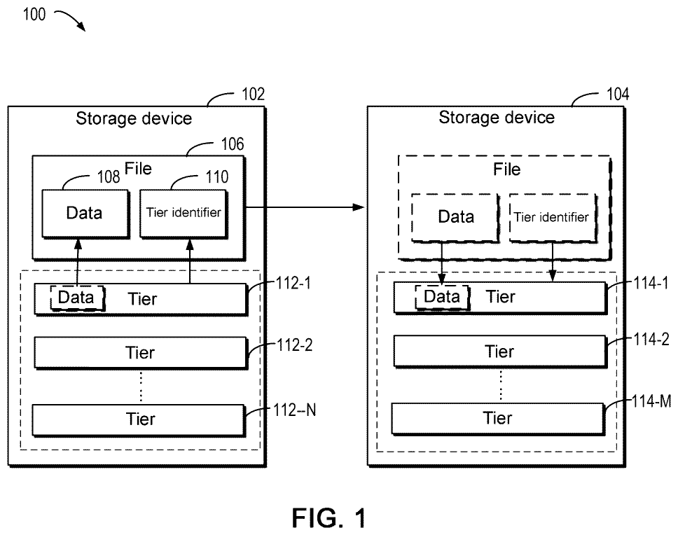

The embodiments of the present disclosure will be further described in detail below with reference to the accompanying drawings, where FIG. 1 illustrates an example environment in which a device and/or a method according to the embodiments of the present disclosure may be implemented.

As shown in FIG. 1, an example environment 100 includes a storage device 102 and a storage device 104. The storage device 102 migrates the files therein to the storage device 104 to continue providing service to the user. For convenience of description, the storage device 102 may also be called a source storage device, and the storage device 104 may also be called a destination storage device.

As shown in FIG. 1, the storage device 102 stores a file 106. In some embodiments, the file 106 is a file in a file system to be migrated. For example, the storage device 104 is a new storage device or a storage device with higher performance. To replace the storage device 102, the file system stored on the storage device 102 needs to be migrated to the storage device 104. The file system to be migrated includes the file 106.

Many types of storage disks are present in the storage device 102, different types of storage disks varying in performance. For example, some storage disks offer higher performance and faster data access, but at a higher cost. Some storage disks, despite lower performance, have a lower cost and can be used for large-capacity storage. Therefore, multiple disks in the storage device 102 may be divided into tiers 112-1, 112-2, . . . , 112-N according to the types or performance of the disks, where N is a positive integer; and for convenience of description, the tiers also may be called tiers 112. Different tiers may be used for storing data varying in activity or temperature. For example, the most active data are stored in a tier with the highest performance, and the tier includes a disk type with the highest processing capacity. The least active data are stored in a tier with the lowest performance, and the tier includes a disk type with the lowest processing capacity. Similarly, the data with medium activity are stored in tiers with medium performance. In addition, these tiers may be arranged in a descending order of performance.

The data of the file 106 are stored in the disks of the storage device. For example, the data 108 of the file are divided into data blocks for storage, and then the data blocks are stored in a tier of the storage device. When the data blocks are stored in the tier, the performance of the tier or the type of the disks in the tier may reflect the activity or temperature of the data. Therefore, when the file is transferred to the destination storage device, in order to retain the activity information of the data, it may also be allowed to further acquire an identifier of the tier where the data blocks of the data are located, and to add the identifier to the attributes of the file. Then, the identifier of the tier and the data are together transferred to the storage device 104.

Like the storage device 102, many types of storage disks are present in the storage device 104, different types of storage disks varying in performance. The disks of different types or performance may be used for storing data varying in activity. Therefore, multiple disks in the storage device 104 may be divided into tiers 114-1, 114-2, . . . , 114-M according to the types or performances of the disks, where M is a positive integer. For convenience of description, the tiers may also be called tiers 114. M may be either identical to or different from N. If M is identical to N, it is indicated that the two storage devices are both divided into tiers of the same number. If M is identical to N, it is indicated that the two storage devices are divided into tiers of different numbers. Likewise, different tiers in the storage device 104 may be used for storing data varying in activity or temperature. In addition, these tiers may be arranged in a descending order of performance.

After acquiring the data of the file and the identifier of the tier, the storage device 104 searches the tiers of the storage device 104 for a tier, e.g., tier 114-1, corresponding to the tier 112-1 according to the received identifier 110 of the tier. For example, the tier 114-1 corresponding to the tier 112-1 may be selected according to a pre-generated mapping relationship between the tiers of the two storage devices. Then, the data blocks of the data of the file are stored in the tier 114-1. Since the tier 114-1 is corresponding to the tier 112-1 in performance, when the data of the file are stored in 114-1, it is indicated that the file transferred to the storage device 104 retains the active temperature information thereof in the storage device 102, thereby ensuring the service quality for user data and reducing the abrasion of disk devices during the file migration process.

The method the method may help retain the active temperature information of the data during data migration, such that the same input and output performance can still be obtained after the data migration, thereby ensuring the service quality for user data and reducing the abrasion of disk devices.

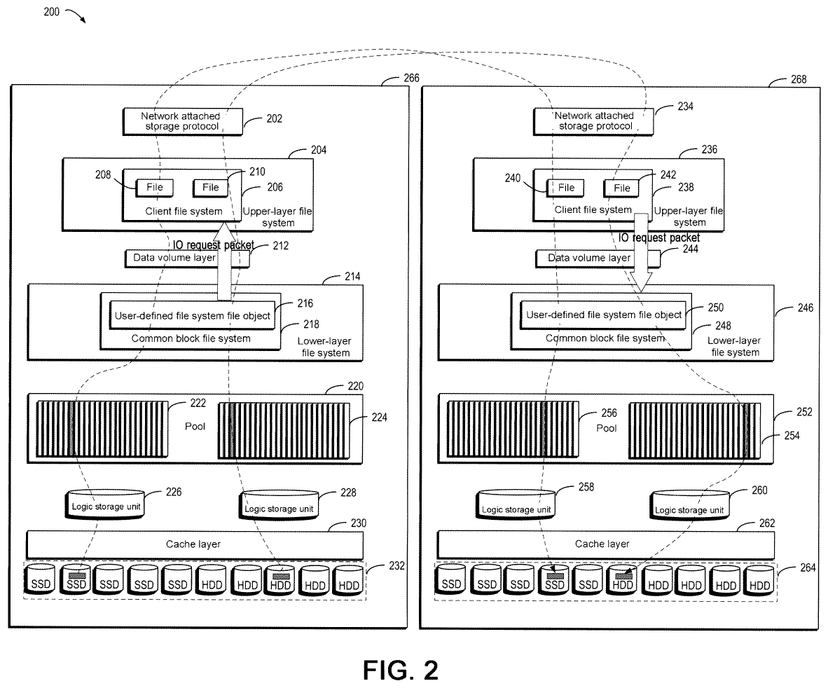

A schematic diagram of an example environment in which a device and/or a method according to the embodiments of the present disclosure may be implemented has been described above with reference to FIG. 1, and a schematic diagram of an example structure of a system for file migration according to the embodiments of the present disclosure will be further described below with reference to FIG. 2.

In an example structure 200, for data migration between multi-layer storage systems, a management layer for implementing the data migration first collects the data usage in a source storage device and the capacity information of a destination storage device to make a migration plan. After the migration plan is made, it may be determined which file systems or files in the source storage device 266 are to be migrated to the destination storage device 268.

A file 208 and a file 210 to be migrated are present in the source storage device 266. The source storage device further includes a disk set 232 for storing data, including various types of disks, such as SSDs (Solid State Drive) and HDDs (Hard Disk Drive). For example, the data of the file 208 are stored in an SSD, while the data of the file 210 are stored in an HDD. With two types of disks, the source storage device 266 is divided into two layers, one layer including SSDs, and the other layer including HDDs.

Take the file 208 as an example, after the file 208 to be migrated is determined according to a file migration request, an identifier of the file 208 may be transferred to a lower-layer file system 214 via an upper-layer file system 204, where the upper-layer file system is mainly used for managing files, while the lower-layer file system is mainly used for managing data blocks.

As shown in FIG. 2, an implementation of the upper-layer file system 204 is a client file system 206, which is merely an example, not a limitation. Files may be processed with any proper specific implementation of the upper-layer file system 204. An implementation of the lower-layer file system 214 is a CBFS (Common Block File System) 218, which is merely an example, not a limitation. Files may be processed with any proper specific implementation of the lower-layer file system 214.

In the transfer of a quest for acquiring the data of the file 208, the request for file data and a tier identifier may be acquired through the transfer of an IRP (IO Request Packet) between the upper-layer file system and the lower-layer file system, and the lower-layer file system returns the data blocks of the file and the tier identifier to the upper-layer file system after acquiring the same. In a process of transferring the file identifier from the upper-layer file system to the lower-layer file system via IRP, it is also required to convert the file identifier into block identifiers of corresponding data blocks via a DVL 212 (Data Volume Layer). The DVL 212 stores the file and a mapping relationship between the data blocks included therein. The lower-layer file system 214 performs processing by use of a user-defined file system object 216. After the file identifier is acquired, the storage locations of the data blocks are determined, such that an SSD slice for storing the data blocks of the file 208 may be determined from an SSD slice set 222 in a storage pool 220, and then the data of the file 208 are further acquired from an SSD via a logic storage unit 226 and a cache layer 230. Meanwhile, after the determination of the locations of the data blocks, a lower-layer storage system may determine an identifier of the tier where the data blocks are located according to the storage locations of the data blocks. With the storage locations of the data blocks, the identifier of the disk storing the data blocks may be obtained. The identifier of the disk including the disk may be further determined using the identifier of the disk.

After acquiring the data blocks of the file 208 and corresponding tier, the identifiers of the data blocks and corresponding tier may be uploaded to the upper-layer file system from the lower-layer file system via an IO request packet. In addition, multiple data blocks and multiple tier identifiers, if present, may be packed into an IO buffer list and are uploaded to the upper-lower file system via an IO request packet, and then the data of the file are determined, where the acquired tier identifier corresponding to the data blocks is further taken as an attribute of the file. Then, the data of the file and the tier identifier are transferred to the destination storage device 268 through a network attached storage protocol 202. The network attached storage protocol may be applicable to an NFS (Network File System) and a CIFS (Common Internet File System).

At the side of the destination storage device 268, the file 208 is received through the network attached storage protocol 202 to generate a file 240 in the upper-layer file system, then is transferred by a client file system 238 in the upper-layer file system 236 to a common block file system 248 in a lower-layer file system 246 via a DVL 244, and then is processed by a user-defined file system object 250. In the lower-layer file system, a tier corresponding to the tier storing the data of the file 208 in the source storage device may be determined according to a mapping relationship between the tiers of the source storage device 266 and the destination storage device 268. Then, an SSD slice that may be used for storing the file 240, in a SSD slice set in the corresponding tier, is determined through the lower-layer file system 246. The SSD slice is located in the SSD slice set 256 in a pool 252. Then, the data are stored in an SSD of a disk set 264 through a logic storage unit 258 and a cache layer 262. Likewise, for the file 210, similar to the file 208, the data and tier identifier are also acquired through a logic storage unit 228 and an HDD slice set 224 corresponding to the same. Then, the data and the tier identifier are sent to the destination storage device to serve as a file 242, thereby realizing the migration of the file 210 through a logic storage unit 260 and an HDD slice set 254, similar to the file 208 in process and components.

The method may help keep the active temperature of the data during data migration. The user may expect to acquire the same performance through successive IO requests for user data.

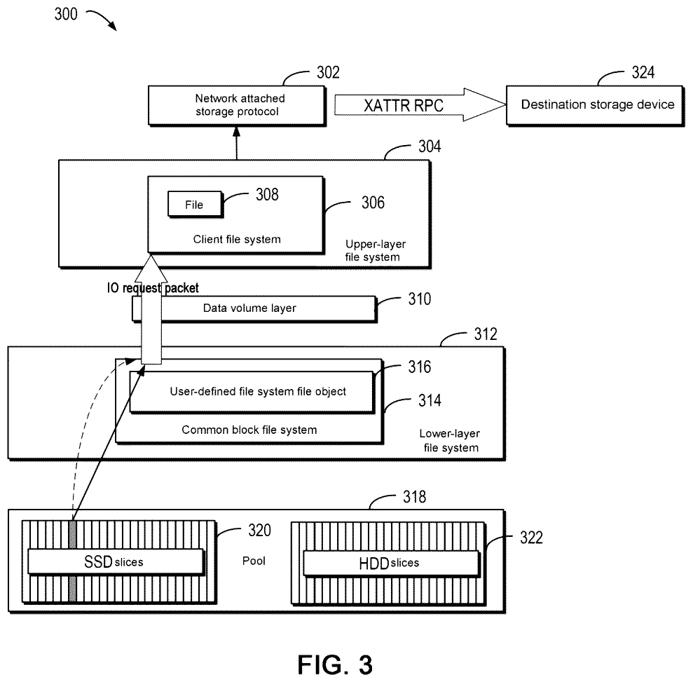

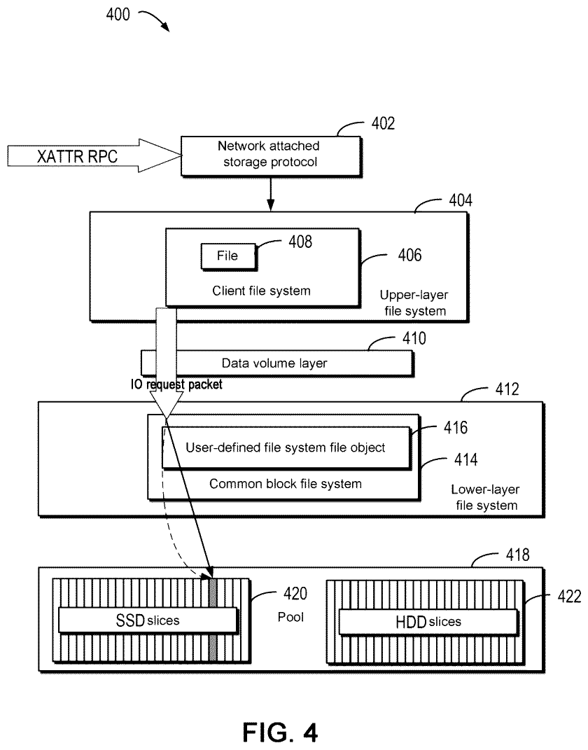

FIG. 2 above illustrates a schematic diagram of an example structure of a system for file migration according to the embodiments of the present disclosure, and FIG. 3 and FIG. 4 below further illustrate schematic diagrams of example structures of a source storage device and a destination storage device, where FIG. 3 illustrates a schematic diagram of an example structure of a source storage device according to the embodiments of the present disclosure, and FIG. 4 illustrates a schematic diagram of an example structure of a destination storage device according to the embodiments of the present disclosure.

In an example 300 of FIG. 3, a source storage device is shown; and in the source storage device, a file 308 is processed by an upper-layer file system 304 (e.g., UD, Upperdeck) and a lower-layer file system 312 (e.g., LD, lowerdeck), to acquire the location of the file 308 in the physical storage device. For example, the upper-layer file system 304 includes a client file system 306 that is a specific implementation thereof, and the lower-layer file system 312 includes a common block file system 314. An IRP (IO Request Packet) is used for transmitting IO requests between UD and LD, and realizing mapping of the file to the data blocks through a DVL 310. Then, a corresponding SSD slice is found from an SSD slice set 320 of a pool 318 according to the storage locations of the data blocks, to further determine the tier information of the data blocks of the file 308, e.g., an identifier of the tier where the data are located. In addition, the pool 318 may also include an HDD slice set 322 composed of HDD slices.

During a migration session, a tier field is added to the migration request to carry the tier information. When the IRP is processed by a CBFS mapping application programming interface in LD, e.g., via a user-defined file system object 316, the actual tier information of the data is recorded together with the requested data blocks in an IRP reply.

For the file migrated in the migration session, extended attributes (XATTR) are used for recording bottom tier information. XATTR is supported in both NFS and SMB. When the read IRP reply reaches a network attached protocol layer 302, the XATTR will be updated in a memory to indicate the tier location information of the file. Then, the XATTR information will be transmitted to a destination storage device 324 through XATTR RPC (Remote Procedure Call).

In an example 400 of FIG. 4, when the XATTR RPC transmits the tier information to the destination storage device, an upper-layer file system 404 will acquire the XATTR via a network attached storage protocol 402. For example, a file 408 is acquired through a client file system 406 of the upper-layer file system. When being written into the file by the migration session, the tier information and the data blocks will be carried by an IO request packet and sent to a lower-layer file system 412, during which the data of the file will be converted into data blocks through a DVL. In IO processing, a common block file system 414 in the lower-layer file system 412 attaches importance to the tier information and writes the data into corresponding tier according to a tier mapping rule. For example, the common block file system 414 may process IO by use of a user-defined file system object 416. In addition, in this process, a DVL 410 is also used to realize division of the data blocks of the file.

For example, a corresponding tier in the destination storage device is determined through the tier identifier in the acquired tier information. Then, an SSD slice for storing the data blocks of the file 408 and corresponding tier is determined from an SSD slice set 420 in a pool 418. In addition, the pool 418 also includes an HDD slice set 422.

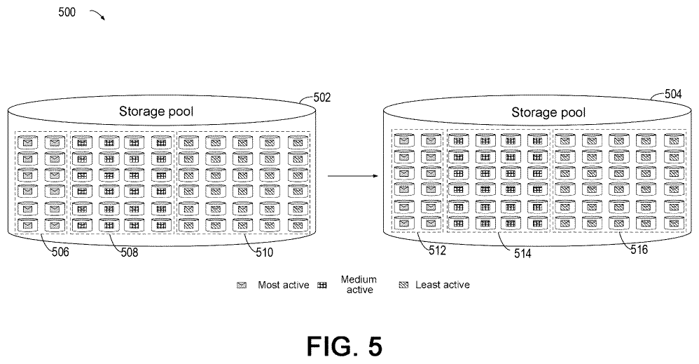

FIG. 5 illustrates a schematic diagram of an example structure of file migration according to the embodiments of the present disclosure. As shown in an example 500 of FIG. 5, a source storage pool 502 includes a first tier composed of a flash disk set 506, a second tier composed of SAS disks 508, and a third tier composed of NL-SAS disks 510 for storing files varying in activity. A destination storage pool 504 includes a first tier composed of a flash disk set 512, a second tier composed of SAS disks 514, and a third tier composed of NL-SAS disks 516. After the completion of migration, the files with the same activity are stored in tiers of the same type or performance respectively.

The method may help perform tiered perceptual migration when the user migrates the network attached storage services to a new platform. The active temperature-based data distribution of the source storage device may be stored at a destination end. Therefore, the network attached storage services can be kept consistent in quality during the migration, to ensure that the user application performance is not affected by the migration. During and after the migration, unnecessary data relocation is avoided, thereby reducing data corruption in a flash layer.

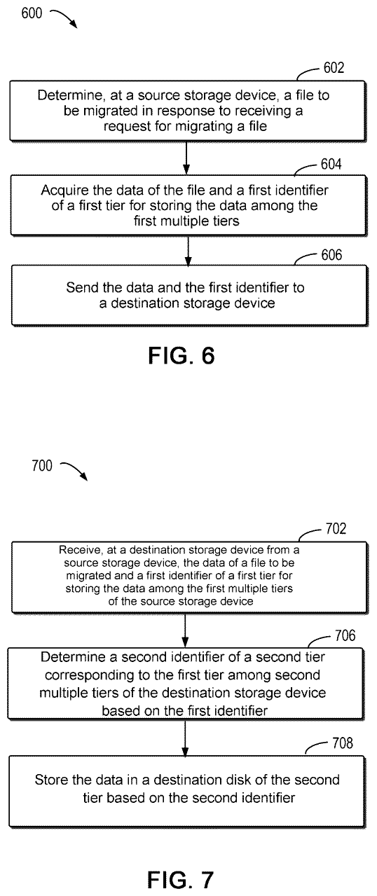

A flow chart of a method 600 for migrating a file according to the embodiments of the present disclosure will be further described below with reference to FIG. 6. The method in FIG. 6 may be performed on the storage device 102 in FIG. 1, the storage device 266 in FIG. 2, or any suitable computing device.

In the block 602, at the source storage device, a file to be migrated is determined in response to receiving a request for migrating a file, where the source storage device generally includes multiple types of disks, different types of storage disks varying in performance. Therefore, multiple disks in the source storage system may be divided into multiple tiers according to the types or performance of the disks, each tier providing a different performance level for data processing. For convenience of description, multiple tiers in the source storage system may also be called first multiple tiers. For example, if two groups of disks are present in the source storage device, a group of SSDs and a group of HDDs, the disks of the source storage device can thus be divided into two tiers, a high-performance tier including the group of SSDs and a low-performance tier including the HDDs. The SSDs, despite a high performance, have a high cost and thus are usually used for storing frequently used data. The HDDs have a low performance but a low cost, and thus a large number of HDDs can be configured to store the data with a low active temperature or temperature. Therefore, the data with a high active temperature can be stored in the SSDs of the high-performance tier, while the data with a low active temperature can be stored in the HDDs of the low-performance tier, thereby enabling different tiers to reflect the usage levels of the data.

The tiers of the source storage device store the data of files or file systems. To migrate a file or file system of the source storage device to a destination storage device, an upper-layer manager sends a request for migrating the file or file system to the source storage device. The request instructs the source storage device about which file systems or files are to be migrated to the destination storage device. After acquiring the request for migrating a file, the source storage device may determine the file to be migrated, e.g., a file identifier of the file to be migrated.

In the block 604, the data of the file and a first identifier of a first tier for storing the data are acquired. In order to transfer the usage of the data of the file to the destination storage device during file migration as well, an identifier of the tier for storing the data of the file in the source storage device may be acquired to reflect the usage of the data.

In some embodiments, when acquiring the data of the file and the first identifier of the first tier for storing the data among the first multiple tiers, the source storage device searches for the block identifiers of data blocks corresponding to the file by use of the file identifier. For example, the source storage device includes a DVL that stores file identifiers and mapping relationships of corresponding data blocks. Thus, the DVL may find the block identifiers of the data blocks corresponding to the file identifier.

Therefore, the data blocks included in the file can be found according to the file identifier. These data blocks have block identifiers. The storage locations of the data blocks can be determined according to these block identifiers. For example, the addresses of the data blocks may be used as the block identifiers. Then, the data stored in the disk are found by use of the block identifiers. Further, an identifier of the tier where the disk for storing the data blocks of the file is located may be determined in this process, and for convenience of description, the tier may be called a first tier, and the identifier thereof may be called a first identifier.

In the block 606, the data and the first identifier are sent to the destination storage device to store the file in a second tier corresponding to the first tier among second multiple tiers of the destination storage device. Here, multiple disks in the destination storage device are divided into second multiple tiers based on types of the disks. Therefore, the destination storage device may also employ different tiers to store the data varying in active temperature.

In some embodiments, when sending the data and the first identifier to the destination storage device, the source storage device adds to the attributes of the file the acquired first identifier of the first tier where the data blocks of the file are located. Then, the data and the attributes of the file are sent to the destination storage device. In an example, when sending the data and the attributes of the file to the destination storage device, the source storage device may send the attributes to the destination storage device via XATTR RPC. In another example, the source storage device may send the identifier of the tier where the data of the file are located to the destination storage device in any proper manner. The method may help retain the active information of the data during data migration, such that the user can still obtain the same input and output performance after the data migration, thereby ensuring the service quality for user data and reducing the abrasion of disk devices.

FIG. 6 above illustrates a flow chart of a method for migrating a file according to the embodiments of the present disclosure, where the method is performed on a source storage device. A flow chart of another method 700 for migrating a file according to the embodiments of the present disclosure will be further described below with reference to FIG. 7. The method in FIG. 7 may be performed on the storage device 104 in FIG. 1, the storage device 268 in FIG. 2, or any suitable computing device.

In the block 702, a destination storage device receives the data of the file to be migrated from the source storage device and the first identifier of the first tier for storing the data among the first multiple tiers of the source storage device. As described in FIG. 6 above, multiple disks in the source storage device are divided into first multiple tiers based on types of the disks. The destination storage device may receive the data of the file to be migrated and the first identifier of the first tier for storing the data of the file in the source storage device through a predetermined protocol.

In the block 704, a second identifier of a second tier corresponding to the first tier among second multiple tiers of the destination storage device is determined based on the first identifier. Here, like the source storage device described in FIG. 6, multiple disks in the destination storage device may also be divided into second multiple tiers according to the types of the disks for storing data varying in active temperature.

In some embodiments, when determining the second identifier of the second tier corresponding to the first tier among the second multiple tiers of the destination storage device, the destination storage device may first acquire a mapping relationship between the first multiple tiers and the second multiple tiers. Then, the destination storage device searches for the second identifier corresponding to the first identifier according to the mapping relationship.

In some embodiments, the destination storage device may acquire the first multiple tiers of the source storage device as well as the types of the disks included therein, and the second multiple tiers of the destination storage device as well as the types of the disks included therein. To ensure that the file data varying in active temperature of user data are stored in corresponding tiers, the mapping relationship between the first multiple tiers and the second multiple tiers may be established according to the disk types. For example, if the source storage device includes a first tier composed of SSDs and a second tier composed of HDDs, and the destination storage device includes a second tier composed of NVME disks and a second tier composed of SSDs, then the first tier of the source storage device may be made corresponding to the first tier of the destination storage device, and the second tier of the source storage device may be made corresponding to the second tier of the destination storage device. Thus, the data of the file with a high active temperature in the source storage device are processed likewise on a high-performance tier in the destination storage device.

In some embodiments, in a migration planning phase, a mapping relationship between the first multiple tiers and the second multiple tiers may be established at the destination storage device. In the establishment of the mapping relationship between the first multiple tiers and the second multiple tiers, if the first multiple tiers and the second multiple tiers are of the same number, the mapping relationship between the first multiple tiers and the second multiple tiers may be established according to a one-to-one correspondence of performance. For example, the first multiple tiers and the second multiple tiers are sorted according to the performance of the tiers, and then a correspondence is established between the tiers of the same place among the ordered first multiple tiers and the ordered second multiple tiers.

In some embodiments, tier mapping needs to be adjusted if the source storage device and the destination storage device differ in tier number or tier capacity. If a first number of the first multiple tiers in the source storage device is greater than a second number of the second multiple tiers in the destination storage device, at least two tiers among the first multiple tiers may be mapped to one tier among the second multiple tiers. If the first number of the first multiple tiers in the source storage device is less than the second number of the second multiple tiers in the destination storage device, a correspondence between tiers may be set according to the performance of the tiers. For example, tiers may be added to the destination storage device, such that the tiers can be matched. As described above, in the establishment of mapping, rules may be added to perform tier mapping between the source storage device and the destination storage device. The tier mapping rules may be customized by the user. In addition, in migration planning, the mapping rules should consider the capacity of each tier.

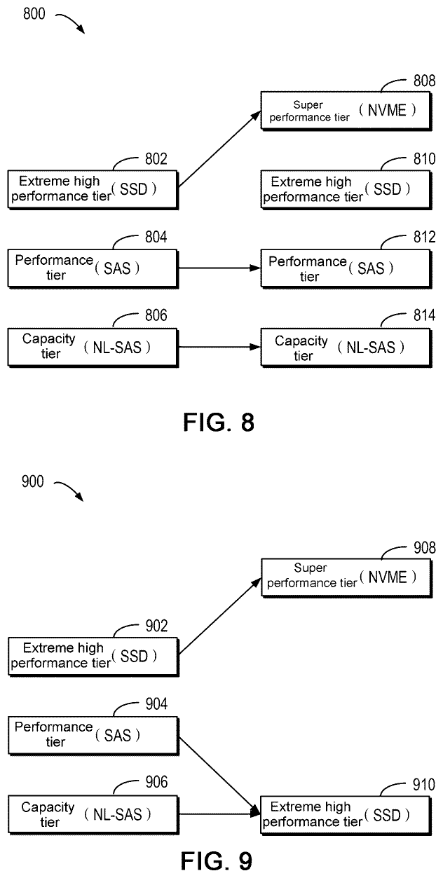

FIG. 8 and FIG. 9 illustrate schematic diagrams of an example 800 and an example 900 of a mapping relationship between tiers according to the embodiments of the present disclosure. As shown in FIG. 8, the source storage device includes three tiers, an extremely high performance tier 802, a performance tier 804, and a capacity tier 806, which are composed of SSDs, SAS disks, and NL-SAS disks respectively. The destination storage device includes four tiers, a super performance tier 808, an extremely high performance tier 810, a performance tier 812, and a capacity tier 814, which are composed of NVME disks, SSDs, SAS disks, and NL-SAS disks respectively. In the establishment of the mapping relationship, a correspondence may be established according to the types and performance of the disks. For example, the extremely high performance tier 802 is corresponding to the super performance tier 808, the performance tier 804 is corresponding to the performance tier 812, and the capacity tier 806 is corresponding to the capacity tier 814.

As shown in FIG. 9, the source storage device includes three tiers, an extremely high performance tier 902, a performance tier 904, and a capacity tier 906, which are composed of SSDs, SAS disks, and NL-SAS disks respectively. The destination storage device includes two tiers, a super performance tier 908 and an extremely high performance tier 910, which are composed of NVME disks and SSDs respectively. In the establishment of the mapping relationship, a correspondence may be established according to the types and performance of the disks. For example, the extremely high performance tier 902 is corresponding to the super performance tier 908, and the performance tier 804 and the capacity tier 906 are corresponding to the extremely high performance tier 910.

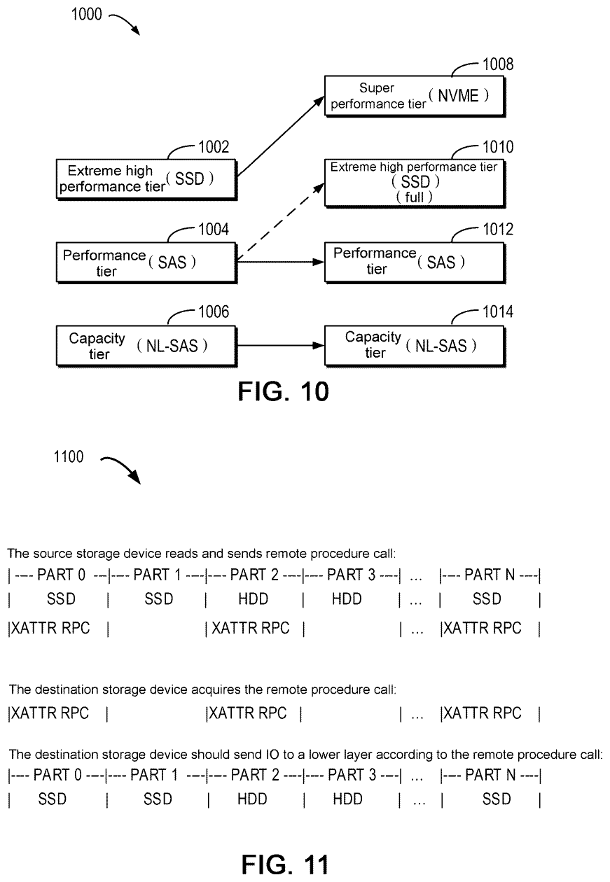

In some embodiments, since it may be possible that a target tier of the destination storage device is full as a result of existing data or other IOs from the client, the tier mapping rules also need to deal with such situation. If the target tier is full, the data will be mapped to a peer tier still having a space available. As shown in FIG. 10, the source storage device includes three tiers, an extremely high performance tier 1002, a performance tier 1004, and a capacity tier 1006, which are composed of SSDs, SAS disks, and NL-SAS disks respectively. The destination storage device includes four tiers, a super performance tier 1008, an extremely high performance tier 1010, a performance tier 1012, and a capacity tier 1014, which are composed of NVME disks, SSDs, SAS disks, and NL-SAS disks respectively. In the establishment of the mapping relationship, a correspondence may be established according to the types and performances of the disks. For example, the extremely high performance tier 1002 is corresponding to the super performance tier 1008, and the capacity tier 1006 is corresponding to the capacity tier 1014. In the establishment of the mapping of the performance tier 1004, the performance tier 1004, which could have been set to correspond to the extremely high performance tier 1010, is made corresponding to the performance tier 1012 since the extremely high performance tier 1010 is full of data.

Return to FIG. 7 to continue the description. In the block 706, the data are stored in a destination disk of the second tier based on the second identifier. After determining the second identifier for storing the data of the file, the destination storage device may divide the data into multiple data blocks. Then, the data blocks of the file, stored in the first tier before, are stored in the destination disk of the second tier indicated by the second identifier.

The method may help retain the active temperature information of the data during data migration, such that the same input and output performance can still be obtained after the data migration, thereby ensuring the service quality for user data and reducing the abrasion of disk devices.

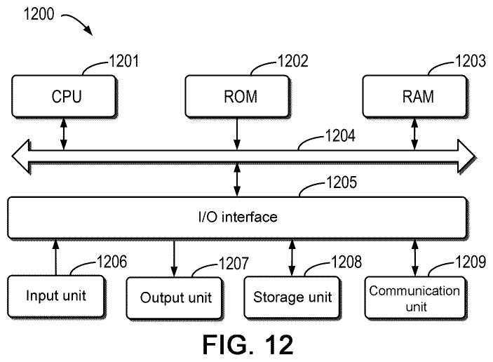

Each file may be migrated using a single thread. For a large file that may be stored across different slices, the XATTR will change when a file read hits a corresponding part. In an example 1100 illustrated by FIG. 11, the file includes N parts, among which a first part PART 0 and a second part PART 1 are stored in SSDs, a third part PART 2 and a fourth part PART 3 till a part PART N−1 are stored in HDDs, and a part PART N is stored in an SSD. Here, a tier identifier is transferred via XATTR RPC when a new disk type is present. Thus, the destination storage device may acquire the attribute information transferred via XATTR RPC. Then, corresponding data part and the tier identifier acquired via XATTR RPC are assigned to a lower tier of the destination storage device for processing. FIG. 12 illustrates a schematic block diagram of an example device 1200 that may be used for implementing embodiments of the present disclosure. The storage devices 102 and 104 in FIG. 1 and the storage devices 266 and 268 in FIG. 2 may be implemented with a device 1200. As illustrated by the figure, the device 1200 includes a central processing unit (CPU) 1201 that may execute various appropriate actions and processing according to computer program instructions stored in a read-only memory (ROM) 1202 or computer program instructions loaded from a storage unit 1208 to a random access memory (RAM) 1203. In the RAM 1203, various programs and data required for operations of the device 1200 may also be stored. The CPU 1201, the ROM 1202, and the RAM 1203 are connected to each other through a bus 1204. An input/output (I/O) interface 1205 is also connected to the bus 1204.

A plurality of components in the device 1200 are connected to the I/O interface 1205, including: an input unit 1206, such as a keyboard and a mouse, and the like; an output unit 1207, such as various types of displays, speakers, and the like; the storage unit 1208, such as a magnetic drive, a compact disc, and the like; and a communication unit 1209, such as a network card, a modem, a wireless communication transceiver, and the like. The communication unit 1209 allows the device 1200 to exchange information/data with other devices via a computer network, such as the Internet, and/or various telecommunication networks.

Various processes and processing described above, such as the methods 600 and 700, may be performed by the CPU 1201. For example, in some embodiments, the methods 600 and 700 may be implemented as a computer software program that is tangibly included in a machine-readable medium, such as the storage unit 1208. In some embodiments, the computer program may be partially or fully loaded and/or installed to the device 1200 via the ROM 1202 and/or the communication unit 1209. When the computer program is loaded to the RAM 1203 and executed by the CPU 1201, one or more actions in the methods 600 and 700 described above may be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer drive, a hard drive, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy drive, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, apparatus (system), and computer program product according to embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce means (e.g., specialized circuitry) for implementing the functions/acts specified in one or more blocks in the flow charts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

1. A method for migrating a file, comprising:
determining, at a source storage device, a file to be migrated in response to receiving a request for migrating a file, wherein multiple disks in the source storage device are divided into first multiple tiers based on types of the disks;
acquiring data of the file and a first identifier of a first tier for storing the data among the first multiple tiers; and
sending the data and the first identifier to a destination storage device, to store the file in a second tier corresponding to the first tier among second multiple tiers of the destination storage device, wherein multiple disks in the destination storage device are divided into second multiple tiers based on types of the disks.

2. The method according to claim 1, wherein determining a file to be migrated comprises:
receiving a request for migrating a file; and
determining a file identifier of the file to be migrated based on the request.

3. The method according to claim 2, wherein acquiring the data of the file and a first identifier of a first tier for storing the data among the first multiple tiers comprises:
determining block identifiers of data blocks corresponding to the file based on the file identifier; and
acquiring the data and the first identifier of the first tier for storing the data blocks based on the block identifiers of the data blocks.

4. The method according to claim 3, wherein acquiring the data and the first identifier of the first tier for storing the data blocks based on the block identifiers of the data blocks comprises:
acquiring the data blocks from a disk storing the data blocks based on the block identifiers; and
determining the tier where the disk for storing the data blocks is located among the first multiple tiers as the first tier.

5. The method according to claim 3, wherein the source storage device comprises a data volume layer, and determining block identifiers of data blocks corresponding to the file based on the file identifier comprises:
determining the block identifiers of the data blocks corresponding to the file identifier through the data volume layer.

6. The method according to claim 1, wherein sending the data and the first identifier to a destination storage device comprises:
adding the first identifier to attributes of the file; and
sending the data and the attributes of the file to the destination storage device.

7. The method according to claim 6, wherein sending the data and the attributes of the file to the destination storage device comprises:
sending the attributes to the destination storage device via Extended Attributes Remote Procedure Call.

8. A method for migrating a file, comprising:
receiving, at a destination storage device, the data of a file to be migrated from a source storage device and a first identifier of a first tier for storing the data among the first multiple tiers of the source storage device, wherein multiple disks in the source storage device are divided into first multiple tiers based on types of the disks;
determining a second identifier of a second tier corresponding to the first tier among second multiple tiers of the destination storage device based on the first identifier, wherein multiple disks in the destination storage device are divided into second multiple tiers based on types of the disks; and
storing the data in a destination disk of the second tier based on the second identifier.

9. The method according to claim 8, wherein determining a second identifier of a second tier corresponding to the first tier among the second multiple tiers of the destination storage device comprises:
acquiring a mapping relationship between the first multiple tiers and the second multiple tiers; and
acquiring the second identifier corresponding to the first identifier based on the mapping relationship.

10. The method according to claim 9, further comprising:
acquiring disk types corresponding to the first multiple tiers and the second multiple tiers; and
establishing the mapping relationship between the first multiple tiers and the second multiple tiers based on the disk types.

11. The method according to claim 10, wherein establishing the mapping relationship between the first multiple tiers and the second multiple tiers comprises:
mapping at least two tiers among the first multiple tiers to a tier among the second multiple tiers, in response to a case where a first number of the first multiple tiers in the source storage device is greater than a second number of the second multiple tiers in the destination storage device.

12. The method according to claim 11, wherein establishing the mapping relationship between the first multiple tiers and the second multiple tiers further comprises:
adjusting, in response to a case where the disks of a third tier to establish a mapping relationship among the second multiple tiers are all full, the mapping for the third tier to a fourth tier among the second multiple tiers.

13. The method according to claim 8, wherein storing the data in a destination disk of the second tier comprises:
dividing the data into multiple data blocks; and
storing the data blocks among the multiple data blocks in the destination disk of the second tier based on the second identifier.

14. A system for migrating a file, comprising:
a source storage device; and
a destination storage device;
wherein the source storage device is configured to:
determine a file to be migrated in response to receiving a request for migrating a file, wherein multiple disks in the source storage device are divided into first multiple tiers based on types of the disks;
acquire data of the file and a first identifier of a first tier for storing the data among the first multiple tiers; and
send the data and the first identifier to the destination storage device; and
the destination storage device is configured to:
receive the data of the file to be migrated and the first identifier from the source storage device;
determine a second identifier of a second tier corresponding to the first tier among second multiple tiers of the destination storage device based on the first identifier, wherein multiple disks in the destination storage device are divided into second multiple tiers based on types of the disks; and
store the data in a destination disk of the second tier based on the second identifier.

15. The system according to claim 14, wherein determining a file to be migrated comprises:
receiving a request for migrating a file; and
determining a file identifier of the file to be migrated based on the request.

16. The system according to claim 15, wherein acquiring the data of the file and a first identifier of a first tier for storing the data among the first multiple tiers comprises:
determining block identifiers of data blocks corresponding to the file based on the file identifier; and
acquiring the data and the first identifier of the first tier for storing the data blocks based on the block identifiers of the data blocks.

17. The system according to claim 16, wherein acquiring the data and the first identifier of the first tier for storing the data blocks based on the block identifiers of the data blocks comprises:
acquiring the data blocks from a disk storing the data blocks based on the block identifiers; and
determining the tier where the disk for storing the data blocks is located among the first multiple tiers as the first tier.

18. The system according to claim 14, wherein sending the data and the first identifier to a destination storage device comprises:
adding the first identifier to attributes of the file; and
sending the data and the attributes of the file to the destination storage device.

19. The system according to claim 14, wherein determining a second identifier of a second tier corresponding to the first tier among the second multiple tiers of the destination storage device comprises:
acquiring a mapping relationship between the first multiple tiers and the second multiple tiers; and
acquiring the second identifier corresponding to the first identifier based on the mapping relationship.

20. The system according to claim 19, wherein the destination storage device is further configured to:
acquire disk types corresponding to the first multiple tiers and the second multiple tiers; and
establish the mapping relationship between the first multiple tiers and the second multiple tiers based on the disk types.
